(19) United States
(12) Patent Application Publication
(10) Pub. No.: US 2019/0052040 A1
(43) Pub. Date: Feb. 14, 2019

(54) JOINED PRODUCT OF CORE WIRE AND OBJECT TO BE JOINED, TERMINAL, ULTRASONIC JOINING DEVICE, AND METHOD FOR JOINING CORE WIRE AND OBJECT TO BE JOINED

(71) Applicant: SUMITOMO WIRING SYSTEMS, LTD., Mie (JP)

(72) Inventors: Takuya SUZUKI, Mie (JP); Tatsuo TAMAGAWA, Mie (JP); Daichi MIURA, Mie (JP)

(73) Assignee: SUMITOMO WIRING SYSTEMS, LTD., Mie (JP)

(21) Appl. No.: 16/078,297

(22) PCT Filed: Feb. 20, 2017
(86) PCT No.: PCT/JP2017/006149

§ 371 Date: Aug. 21, 2018

(30) Foreign Application Priority Data
Feb. 25, 2016 (JP) 2016-033880

(51) Int. Cl. H01R 43/02; H01R 4/18; H01R 43/048

(52) U.S. Cl. CPC H01R 43/0207; H01R 4/185; H01R 11/12; H01R 43/0484; H01R 43/0249; H01R 4/187

(57) ABSTRACT

An object is to allow an end portion of a core wire including a plurality of element wires and an object to be joined to be joined with as high a joining strength as possible. A joined product of a core wire including a plurality of element wires and an object to be joined includes a core wire including a plurality of element wires, and an object to be joined (e.g., a terminal) that has been ultrasonically joined to the core wire while being stacked on the core wire. The distance between a part of the core wire that has been joined to the object to be joined and a part thereof located opposite thereto gradually increases toward a distal end side of the core wire, at least partly in a direction in which the core wire extends.

### TECHNICAL FIELD

The present invention relates to a technique for ultrasonically joining a core wire including a plurality of element wires to an object to be joined.

BACKGROUND ART

Patent Document 1 discloses a technique for ultrasonically joining an electric wire joining portion of a terminal and a core wire of an electric wire, with the electric wire joining portion and the core wire sandwiched between an anvil and an ultrasonic horn.

### CITATION LIST

### Patent Document

Patent Document 1: JP 2014-143177A

SUMMARY OF INVENTION

### Technical Problem

However, a sufficient joining strength may not be obtained when the electric wire joining portion of the terminal and the core wire of the electric wire are ultrasonically joined in the manner as disclosed in Patent Document 1.

It is an object of the present invention to allow an end portion of a core wire including a plurality of element wires and an object to be joined to be joined with as high a joining strength as possible.

### Solution to Problem

In order to solve the above-described problem, a joined product of a core wire and an object to be joined according to a first aspect includes: a core wire including a plurality of element wires; and an object to be joined that has been ultrasonically joined to the core wire while being stacked on the core wire, wherein a distance between a part of the core wire that has been joined to the object to be joined and a part thereof located opposite thereto gradually increases toward a distal end side of the core wire, at least partly in a direction in which the core wire extends.

A second aspect provides the joined product of a core wire and an object to be joined according to the first aspect, wherein the object to be joined is a core wire connection portion of a terminal.

In order to solve the above-described problem, a terminal according to a third aspect includes a core wire connection portion including a plate-shaped part; and a counterpart connection portion provided continuously with one end portion of the core wire connection portion, wherein the plate-shaped part includes an inclined surface whose height distance gradually decreases toward the counterpart connection portion.

In order to solve the above-described problem, a fourth aspect provides an ultrasonic joining device for ultrasonically joining a core wire including a plurality of element wires and an object to be joined, including: a pair of pressurization members that sandwich therebetween a stack of an end portion of the core wire and an object to be joined; and an ultrasonic vibration source that applies ultrasonic vibrations to one of the pair of pressurization members, wherein an interval between a surface to be joined of the object to be joined supported by one of the pair of pressurization members and a part of the other of the pair of pressurization members that presses the end portion of the core wire is set to gradually increase toward a distal end side of the core wire, at least partly in a direction in which the core wire extends.

A fifth aspect provides the ultrasonic joining device according to the fourth aspect, wherein one of the pair of pressurization members includes a placement portion that supports the object to be joined, with the object to be joined placed thereon, the other of the pair of pressurization members includes a pressing portion that presses an end portion of the core wire that is stacked on the object to be joined, and the placement portion is shaped so as to support the object to be joined in an orientation in which the object to be joined gradually recedes from the pressing portion toward the distal end side of the core wire.

A sixth aspect provides the ultrasonic joining device according to the fifth aspect, wherein the placement portion is shaped so as be recessed on the distal end side of the core wire, and to support the object to be joined such that the object to be joined is inclined downward at the distal end side of the core wire.

In order to solve the above-described problem, a seventh aspect provides a method for joining a core wire and an object to be joined for ultrasonically joining a core wire including a plurality of element wires and an object to be joined, including the steps of: (a) sandwiching, between a pair of pressurization members, a stack of an end portion of the core wire and an object to be joined; and (b) in a state in which a force directed to a distal end side of the core wire is exerted on those of the plurality of element wires that are located on a side of the object to be joined, ultrasonically joining the stack of the end portion of the core wire and the object to be joined sandwiched between the pair of pressurization members.

An eighth aspect provides the method for joining a core wire and an object to be joined according to the seventh aspect, wherein, in the step (b), the ultrasonic joining is performed in a state in which an interval between a surface to be joined of the object to be joined that is supported by one of the pair of pressurization members and a part with which the other of the pair of pressurization members presses the end portion of the core wire gradually increases toward a distal end side of the core wire, at least partly in a direction in which the core wire extends.

A ninth aspect provides the method for joining a core wire and an object to be joined according to the seventh aspect, wherein, in the step (b), the ultrasonic joining is performed in a state in which an interval between positions at which the pair of pressurization members respectively pressurize the stack of the end portion of the core wire and the object to be joined gradually increases toward a distal end side of the core wire, at least partly in a direction in which the core wire extends.

A tenth aspect provides the method for joining a core wire and an object to be joined according to any one of the seventh to ninth aspects, wherein the object to be joined is a core wire connection portion of a terminal.

### Advantageous Effects of Invention

According to the first aspect, a distance between a part of the core wire that has been joined to the object to be joined and a part thereof located opposite thereto gradually increases toward a distal end side of the core wire, at least partly in a direction in which the core wire extends. Accordingly, at the time of joining the core wire and the object to be joined, a force directed to the distal end side of the core wire can be exerted on the plurality of element wires. Consequently, the element wires are less likely to be displaced between the core wire and the object to be joined, allowing the end portion of the core wire and the object to be joined to be joined with as high a joining strength as possible.

According to the second aspect, the end portion of the core wire and the object to be joined can be joined with as high a joining strength as possible.

According to the third aspect, the plate-shaped part includes an inclined surface whose height distance gradually decreases toward the counterpart connection portion. Accordingly, at the time of ultrasonically joining a core wire including a plurality of element wires to the plate-shaped part, it is possible to ultrasonically join the end portion of the core wire and the object to be joined in a state in which a force directed to the distal end side of the core wire is exerted on the plurality of element wires. Consequently, the element wires are less likely to be displaced between the core wire and the object to be joined, allowing the end portion of the core wire and the object to be joined to be joined with as high a joining strength as possible.

According to the fourth aspect, an interval between a surface to be joined of the object to be joined supported by one of the pair of pressurization members and a part of the other of the pair of pressurization members that presses the end portion of the core wire is set to gradually increase toward a distal end side of the core wire, at least partly in a direction in which the core wire extends. Accordingly, it is possible to ultrasonically join a stack of the end portion of the core wire and the object to be joined in a state in which a force directed to the distal end side of the element wires of the core wire is exerted on the element wires. Consequently, the element wires are less likely to be displaced between the end portion of the core wire and the object to be joined during ultrasonic joining. Accordingly, the end portion of the core wire and the object to be joined can be joined with as high a joining strength as possible.

According to the fifth aspect, the object to be joined is supported by the placement portion in an orientation in which the object to be joined gradually recedes from the pressing portion toward the distal end side of the core wire. Accordingly, the force directed to the distal end side of the element wires of the core wire can be easily exerted on the element wires.

According to the sixth aspect, with the placement portion having a simple shape, the object to be joined can be supported and inclined downward on the distal end side of the core wire.

According to the seventh aspect, the stack of the end portion of the core wire and the object to be joined sandwiched between the pair of pressurization members is ultrasonically joined in a state in which a force directed to a distal end side of the core wire is exerted on those of the plurality of element wires that are located on a side of the object to be joined. Therefore, the element wires are less likely to be displaced between the core wire and the object to be joined. Accordingly, the end portion of the core wire and the object to be joined can be joined with as high a joining strength as possible.

According to the eighth aspect, in the step (b), the ultrasonic joining is performed in a state in which an interval between a surface to be joined of the object to be joined that is supported by one of the pair of pressurization members and a part with which the other of the pair of pressurization members presses the end portion of the core wire gradually increases toward a distal end side of the core wire, at least partly in a direction in which the core wire extends. Accordingly, the force directed to the distal end side of the element wires of the core wire can be easily exerted on the element wires.

According to the ninth aspect, in the step (b), the ultrasonic joining is performed in a state in which an interval between positions at which the pair of pressurization members respectively pressurize the stack of the end portion of the core wire and the object to be joined gradually increases toward a distal end side of the core wire, at least partly in a direction in which the core wire extends. Accordingly, the force directed to the distal end side of the element wires of the core wire can be easily exerted on the element wires.

According to the tenth aspect, the end portion of the core wire and the object to be joined can be joined with as high a joining strength as possible.

### BRIEF DESCRIPTION OF DRAWINGS

FIG. 1 is a diagram showing how a core wire and a terminal are ultrasonically joined according to the related art.

FIG. 2 is a graph showing the fixing strength of a plurality of samples each obtained by ultrasonically joining the core wire and the terminal according to the related art.

FIG. 3 is a diagram showing the relationship between element wires and the terminal according to the related art.

FIG. 4 is a schematic perspective view showing a joined product of a core wire and a terminal.

FIG. 5 is a schematic cross-sectional view of the same joined product.

FIG. 6 is a schematic perspective view showing an ultrasonic joining device.

FIG. 7 is a schematic perspective view showing a state in which the terminal is supported on a placement portion of an anvil.

FIG. 8 is a diagram showing an example of a method for forming the placement portion.

FIG. 9 is a diagram showing how the core wire and a bottom portion of the terminal are ultrasonically joined between the anvil and a sonotrode.

FIG. 10 is a schematic diagram showing an anvil according to a first modification.

FIG. 11 is a schematic diagram showing an anvil and a sonotrode according to a second modification.

FIG. 12 is a schematic diagram showing a terminal according to a third modification.

FIG. 13 is a schematic diagram showing the terminal according to the third modification.

FIG. 14 is a schematic diagram showing a fourth modification in which it is assumed that a core wire is used as an object to be joined.

FIG. 15 is a graph showing the fixing strength of a plurality of samples each obtained by ultrasonically joining the core wire and the terminal according to an embodiment.

### DESCRIPTION OF EMBODIMENTS

### Description relating to Background

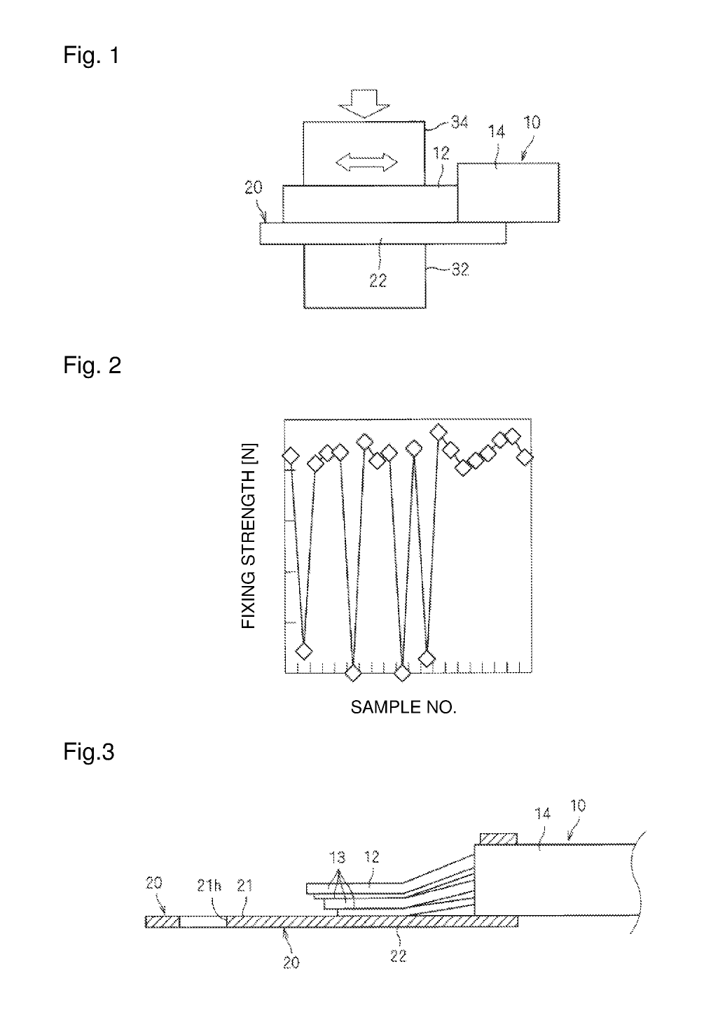

For the sake of convenience of description, the background of the present technique will be described. FIG. 1 is a diagram showing how a core wire 12 and an electric wire connection portion 22 of a terminal 20 are ultrasonically joined.

An electric wire 10 includes a core wire 12 and a coating 14. The coating 14 at an end portion of the electric wire 10 is removed to expose the core wire 12 at the end portion of the electric wire 10. The core wire 12 is constituted by an aggregate (ordinarily, a strand) of a plurality of element wires.

The terminal 20 is formed, for example, by press forming a metal plate. An electric wire connection portion 22 including a plate-shaped part is formed at one end portion of the terminal 20. The core wire 12 is ultrasonically joined to a first principal surface of the electric wire connection portion 22.

The ultrasonic joining device 30 includes a pair of pressurization members 32, 34. Then, with the electric wire connection portion 22 disposed on one of the pressurization members, namely, the pressurization member 32, the core wire 12 is disposed on the electric wire connection portion 22, and both are pressed from above by the other pressurization member 34. That is, a stack of the electric wire connection portion 22 and the core wire 12 is sandwiched between the pair of pressurization members 32, 34. In this state, ultrasonic vibrations are applied to the other pressurization member. Thus, the electric wire connection portion 22 and the core wire 12 are ultrasonically joined.

The present inventors produced a plurality of objects each obtained by ultrasonically joining the core wire 12 and the electric wire connection portion 22, and measured the fixing strength of each of the objects. As a result, it was found that some of the many samples had a very small fixing strength as shown in FIG. 2. Note that the fixing strength is the tensile strength between the terminal and the electric wire.

A study made by the present inventors on the cause of the above-described problem showed that the reason for this is that those of the plurality of element wires 13 constituting the core wire 12 that are located close to the electric wire connection portion 22 slipped relative to the electric wire connection portion 22 by ultrasonic vibrations, as shown in FIG. 3. That is, individual element wires 13 constituting the core wire are relatively thin linear bodies, and thus can withstand a certain degree of a force in the stretching direction. However, they are relatively easily bent when a force in the compressing direction is applied thereto. Therefore, if ultrasonic joining is performed in the above-described manner, those of the plurality of element wires 13 that are located close to the electric wire connection portion 22 will gradually move to the proximal end side thereof. Consequently, during ultrasonic joining, a portion of the electric wire connection portion 22 that is to be brought into contact and a portion of the core wire 12 that is to be brought into contact gradually change, making it difficult to widen the contact area in which the electric wire connection portion 22 and the core wire 12 are brought into proximity to each other to such a degree that their metal atoms can be bonded together. Since those of the plurality of element wires 13 that are located close to the electric wire connection portion 22 are displaced toward the proximal end side thereof by ultrasonic vibrations, the contact area between the core wire 12 and the electric wire connection portion 22 will be decreased.

The present inventors found the cause as described above, and, from their unique point of view, have arrived at the conclusion that at the time of ultrasonically joining a core wire 12 including a plurality of element wires 13 and an object to be joined, such as an electric wire connection portion 22, a joining method may be adopted that includes the steps of: sandwiching, between a pair of pressurization members 32, 34, a stack of an end portion of the core wire 12 and an object to be joined, such as the electric wire connection portion 22 (step (a)); and in a state in which a force directed to a distal end side of the core wire 12 is exerted on those of the plurality of element wires 13 that are located on the side of the object to be joined, such as the electric wire connection portion 22, ultrasonically joining the stack of the end portion of the core wire 12 and the object to be joined, such as the electric wire connection portion 22, sandwiched between the pair of pressurization members 32, 34 (step (b)).

With this method, the element wires are less likely to be displaced between the core wire 12 and the object to be joined, such as the electric wire connection portion 22, during ultrasonic joining, thus allowing the end portion of the core wire 12 and the object to be joined, such as the electric wire connection portion 22, to be joined with as high a joining strength as possible.

In the following, a method for joining a core wire and an object to be joined, an ultrasonic joining device, a joined product of a core wire and an object to be joined, and a terminal according to a more specific embodiment will be described.

### Embodiment

### Joined Product of Core Wire and Object to be Joined

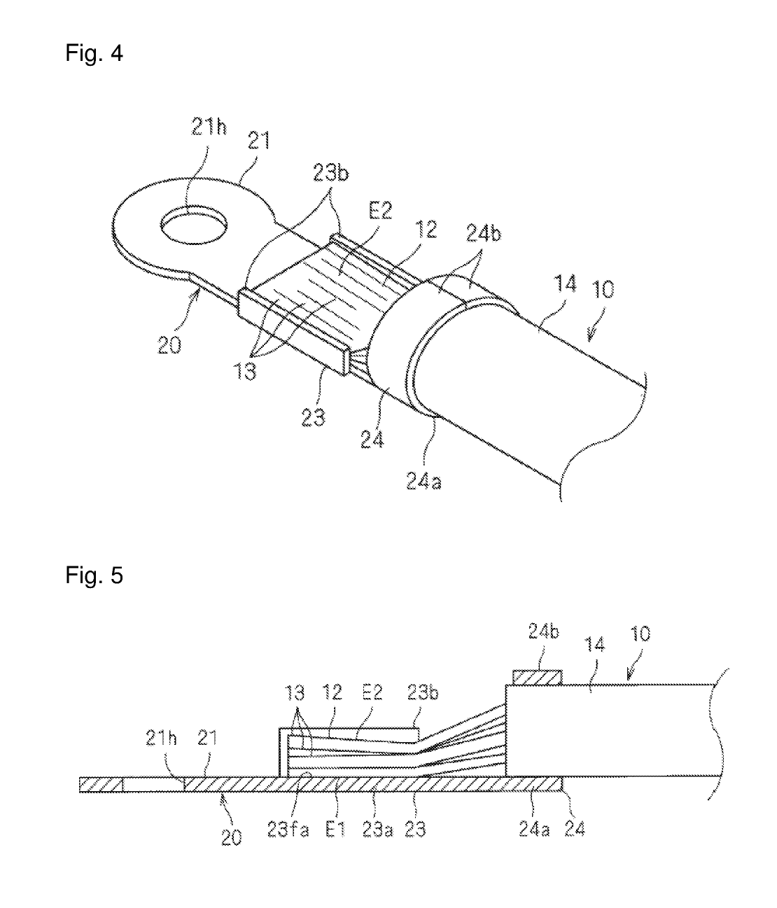

First, a joined product of a core wire and an object to be joined will be described. Here, a description will be given of a case where the object to be joined is a terminal 20, or in other words, a joined product of a core wire 12 and a terminal 20. FIG. 4 is a schematic perspective view showing a joined product of a core wire 12 and a terminal 20. FIG. 5 is a schematic cross-sectional view of the joined product.

The core wire 12 is an aggregate of a plurality of element wires 13. Ordinarily, the plurality of element wires 13 are twisted together. Each element wire 13 is formed by a metal wire of copper, a copper alloy, aluminum, an aluminum alloy, or the like. A coating 14 is formed on the outer circumference of the core wire 12 by extrusion coating of resin, for example. That is, the core wire 12 is the core wire 12 of the electric wire 10. The coating 14 is removed at an end portion of the electric wire 10 to expose an end portion of the core wire 12 at the end portion of the electric wire 10. The coating 14 may not necessarily be formed on the circumference of the core wire 12. As the core wire 12, a braided wire obtained by braiding metal wires into a tubular form may be used.

The terminal 20 is a member formed by press forming a metal plate of copper, a copper alloy, or the like, and includes a counterpart connection portion 21 and an electric wire connection portion 22.

The counterpart connection portion 21 is a portion to be connected to a conductive portion of a counterpart component such as a counterpart terminal or a metal body of a vehicle. Here, the counterpart connection portion 21 is configured as a plate-shaped part (here, a circular plate) having a bolt insertion hole 21h formed therein. That is, here, it is assumed that a round terminal for use as a ground terminal is used as the terminal 20. The counterpart connection portion 21 may also be formed in another shape such as the shape of a tab- or pin-shaped male terminal, or the shape of a circular or angular cylindrical female terminal.

The electric wire connection portion 22 is a portion to be connected to the electric wire 10. The electric wire connection portion 22 is a portion provided continuously with one end portion of the counterpart connection portion 21 described above, and includes a core wire connection portion 23 and a coating connection portion 24. The core wire connection portion 23 is provided on the side close to the counterpart connection portion 21, and the coating connection portion 24 is provided on the side distant from the counterpart connection portion 21.

The core wire connection portion 23 includes a plate-shaped bottom portion 23a and a pair of side wall portions 23b located on opposite sides thereof. The bottom portion 23a is continuous with the counterpart connection portion 21, and the pair of side wall portions 23b are provided upright from the opposite side portions of the bottom portion 23a toward the first principal surface side of the bottom portion 23a. The core wire 12 is ultrasonically joined to the first principal surface of the bottom portion 23a between the pair of side wall portions 23b. Note that the pair of side wall portions 23b may be omitted.

The coating connection portion 24 includes a bottom portion 24a and a pair of crimping pieces 24b. The bottom portion 24a is continuous with the bottom portion 23a described above, and extends to the side opposite to the counterpart connection portion 21. The pair of crimping pieces 24b stand upright at the two end portions of the bottom portion 24a from the first principal surface side of the bottom portion 24a. With an end portion of the coating 14 disposed on the first principal surface of the bottom portion 24a, the pair of crimping pieces 24b are inwardly crimped and deformed. Consequently, the end portion of the coating 14 is crimped to be fixed between the bottom portion 24a and the pair of crimping pieces 24b. Note that the coating connection portion 24 may be omitted.

Since the core wire 12 and the bottom portion 23a are pressurized and ultrasonically joined, while being stacked on each other, the joining portion therebetween has a structure in which the core wire 12 and the bottom portion 23a are stacked in a flat state. Note that the core wire 12 and the bottom portion 23a are ultrasonically joined, and the plurality of element wires 13 are also ultrasonically joined to each other.

At the time of ultrasonic joining, a force directed to the distal end side of the core wire 12 is exerted on those of the plurality of element wires 13 that are located on the electric wire connection portion 22 side, thus forming a shape in which the distance between a part (see a boundary surface E1 in FIG. 5) of the core wire 12 that has been joined to the bottom portion 23a and a part (see a surface E2 on the upper side in FIGS. 4 and 5) located opposite thereto gradually increases toward the distal end side of the core wire 12, at least partly in a direction in which the core wire 12 extends. Accordingly, those of the plurality of element wires 13 that are located close to the bottom portion 23a are also less likely to be displaced to the proximal end side, compared with the others. This makes it possible to suppress the displacement between the core wire 12 and the bottom portion 23a at the time of ultrasonically joining them, and also provide a sufficient joining area therebetween in the joined state. Accordingly, the end portion of the core wire 12 and the bottom portion 23a of the terminal 20 can be joined with as high a joining strength as possible.

### Ultrasonic Joining Device

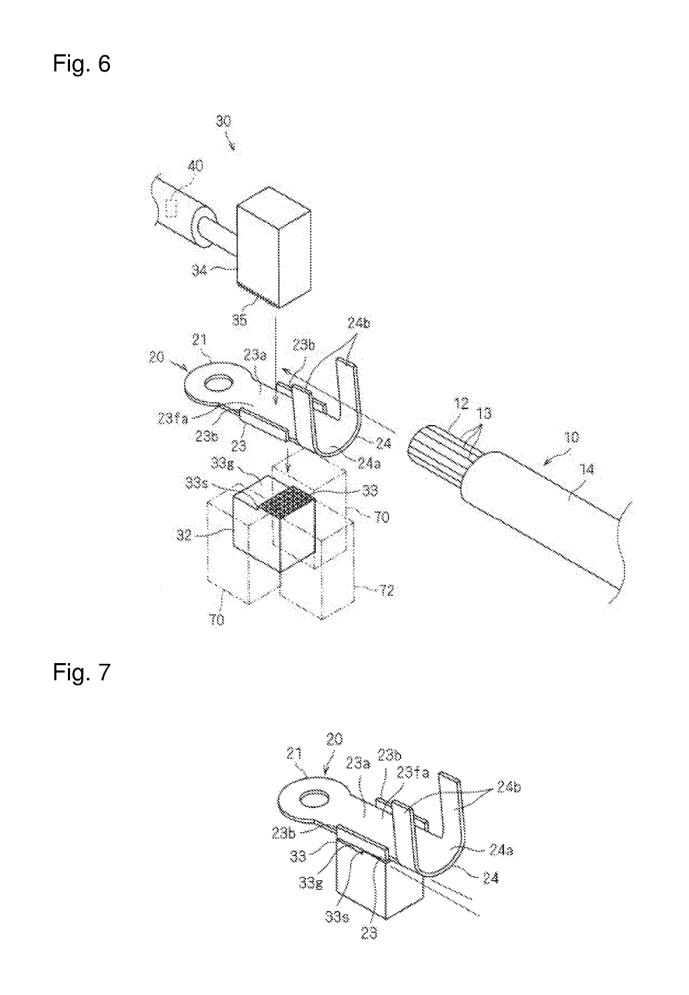

An example of an ultrasonic joining device suitable to produce the above-described joined product will now be described. FIG. 6 is a schematic perspective view showing an ultrasonic joining device 30.

The ultrasonic joining device 30 serves to ultrasonically join the core wire 12 and the terminal 20 described above, and includes a pair of pressurization members 32, 34 and an ultrasonic vibrator 40.

The pair of pressurization members 32, 34 are able to sandwich therebetween a stack of the core wire 12 and the bottom portion 23a of the core wire connection portion 23 of the terminal 20.

Here, one of the pair of pressurization members 32, 34 is an anvil 32 that is able to support the bottom portion 23a of the core wire connection portion 23 of the terminal 20, with the bottom portion 23a placed thereon. On an upper face of the anvil 32, a placement portion 33 is provided that supports the bottom portion 23a of the core wire connection portion 23 of the terminal 20, with the bottom portion 23a placed thereon. The anvil 32 itself is formed, for example, in a shape in which both corner portions on one side of a rectangular solid-shaped block have been cut off (a home base shape when viewed from above). The shape of the anvil is not particularly limited as long as the shape allows the anvil to support the bottom portion 23a, with the bottom portion 23a placed thereon. In FIG. 6 etc., the anvil 32 is depicted in a simplified shape.

The other of the pair of pressurization members 32, 34 is a sonotrode 34 that is disposed above and opposed to the anvil 32 and is able to move toward and away from the anvil 32. Below the sonotrode 34, a pressing portion 35 is formed that presses an end portion of the core wire 12 stacked on the bottom portion 23a. The sonotrode 34 itself is formed in, for example, a vertically elongated plate shape, and its front face (face on the electric wire side) is formed in a shape that is gradually inclined to the proximal end side (the distal end side of the terminal), toward the upper end side and the lower end side. The shape of the sonotrode 34 is not limited as long as the shape allows the sonotrode 34 to press the core wire 12 from the upper side of the bottom portion 23a. In FIG. 6 etc., the sonotrode 34 is depicted in a simplified shape.

An ultrasonic vibrator 40 that generates ultrasonic vibrations is coupled to the sonotrode 34, and the ultrasonic vibrations generated by the ultrasonic vibrator 40 are applied to the core wire 12 and the bottom portion 23a via the sonotrode 34. Ordinarily, ultrasonic vibrations are applied to the core wire 12 and the bottom portion 23a as vibrations in a direction along the direction in which the core wire 12 extends.

The placement portion 33 and the pressing portion 35 are shaped such that the interval between a surface to be joined (upper face) of the bottom portion 23a, which is the object to be joined, supported on the anvil 32, and the pressing portion 35 with which the sonotrode 34 presses an end portion of the core wire 12 can be set to gradually increase toward the distal end side of the core wire 12, at least partly in the direction in which the core wire 12 extends.

Here, the downward pressing portion 35 of the sonotrode 34 is formed on a surface extending along a horizontal direction (direction perpendicular to the direction of gravity).

The upward placement portion 33 of the anvil 32 is shaped to support the bottom portion 23a in an orientation in which the bottom portion 23a gradually recedes from the pressing portion 35 toward the distal end side of the core wire 12. More specifically, the placement portion 33 is formed in a shape in which a part of the core wire 12 on the distal end side is recessed relative to a part of the core wire 12 on the proximal end side via a step portion 33S. By applying a downward force to the bottom portion 23a with the bottom portion 23a placed on the placement portion 33, a part of the bottom portion 23a that is located on the distal end side of the core wire 12 moves so as to subside into a recess 33g of the placement portion 33 that is located on the distal end side of the core wire 12 in a state in which a part of the bottom portion 23a that is located on the proximal end side of the core wire 12 is supported at the position on the upper side of the step portion 33S, as shown in FIG. 7. Consequently, the bottom portion 23a is supported on the placement portion 33 in an orientation in which the bottom portion 23a is inclined downward toward the distal end side of the core wire 12.

Accordingly, by sandwiching and pressurizing the bottom portion 23a and the core wire 12 between the placement portion 33 and the pressing portion 35, the interval between the surface to be joined (upper face) of the bottom portion 23a and the pressing portion 35 gradually increases toward the distal end side of the core wire 12, at least partly in the direction in which the core wire 12 extends.

Note that the placement portion 33 and the pressing portion 35 may have a smooth surface, or may have a surface on which fine projections and depressions are formed in order to suppress slippage relative to he bottom portion 23a or the core wire 12. FIG. 6 shows the pressing portion 35 in which V-shaped projections extending along the width direction are formed in parallel along the direction in which the core wire 12 extends. FIG. 6 also shows that quadrangular pyramid-shaped projections are formed without any gap at a higher part of the placement portion 33 via the step portion 33S.

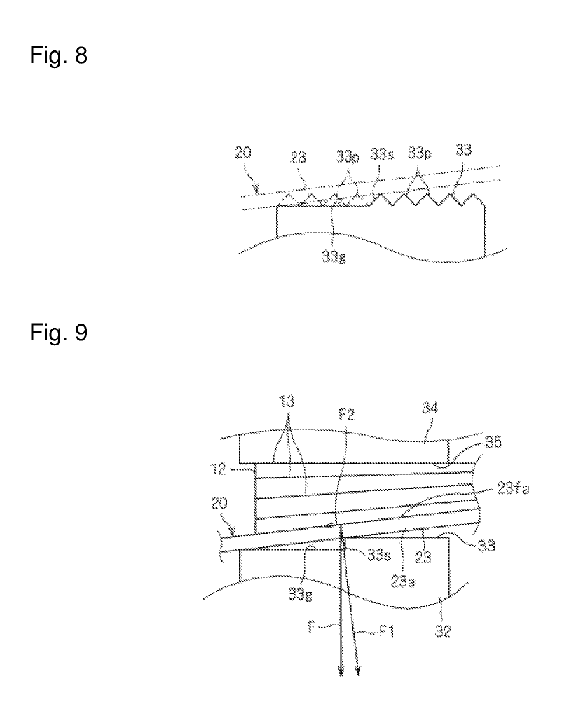

Note that when a configuration in which a plurality of projections are formed on the entire upper surface of an anvil is changed to a configuration in which the bottom portion 23a is supported in an inclined orientation on the upper face of the anvil, the portion of projections 33P formed on the distal end side of the core wire 12, out of a plurality of projections 33P formed on the upper face of an anvil 32, may be cut off, and the projections 33P formed on the proximal end side of the core wire 12 may be left on the upper face of the anvil 32, as shown in FIG. 8. In this case, a part of the anvil 32 that is located on the distal end side of the core wire 12 can support the bottom portion 23a at a position lower by the height distance of the projection 33P than a part thereof located on the proximal end side, and thus can support the bottom portion 23a in an inclined orientation. In this case, a commonly used anvil can be configured to support the bottom portion 23a in an inclined orientation by simple and slight processing.

Referring back to FIG. 6, auxiliary support portions 70 that press and support the terminal 20 from opposite sides are provided on opposite end portions of the anvil 32. Below the side on which the coating connection portion 24 extends relative to the anvil 32, an auxiliary placement portion 72 is provided that supports the coating connection portion 24 with the coating connection portion 24 placed thereon. The auxiliary support portions 70 and the auxiliary placement portion 72 may also be omitted.

### Joining Method

A method for joining the core wire 12 and the terminal 20 by using the ultrasonic joining device 30 described above will be described.

First, a stack of an end portion of the core wire 12 and the bottom portion 23a of the terminal 20 is sandwiched between the anvil 32 and the sonotrode 34. Specifically, the bottom portion 23a of the terminal 20 is placed on the placement portion 33 of the anvil 32. Also, the core wire 12 exposed at an end portion of the electric wire 10 is disposed on the bottom portion 23a. Then, the sonotrode 34 is lowered to press the pressing portion 35 against the upper portion of the core wire 12 on the side opposite to the bottom portion 23a.

Then, as shown in FIG. 9, in a state in which a force directed to the distal end side of the core wire 12 is exerted on those of the plurality of element wires 13 that are located on the bottom portion 23a side, the stack of the end portion of the core wire 12 and the bottom portion 23a sandwiched between the anvil 32 and the sonotrode 34 is ultrasonically joined. In this state, the bottom portion 23a is inclined downward toward the distal end side of the core wire 12, as described above. Accordingly, a force F that moves the sonotrode 34 downward acts as a force F1 that perpendicularly presses the plurality of element wires 13 (including those located close to the bottom portion 23a) included in the core wire 12 against a surface to be joined 23fa of the bottom portion 23a, and a force F2 that pushes the plurality of element wires 13 toward the distal end side of the core wire 12. This makes it possible to ultrasonically join the core wire 12 and the bottom portion 23a while keeping the element wires 13 from being displaced to the proximal end side of the core wire 12 relative to the bottom portion 23a. Although the element wires 13 may be slightly displaced relative to the bottom portion 23a at this time, the displacement is small compared with the case shown in FIG. 1. Accordingly, the joining strength is improved considerably.

### Effects, Etc.

With the method for joining a core wire and an object to be joined, the ultrasonic joining device, etc., configured in the above-described manner, a stack of the end portion of the core wire 12 and the bottom portion 23a sandwiched between the anvil 32 and the sonotrode 34 is ultrasonically joined in a state in which a force directed to the distal end side of the core wire 12 is exerted on those of the plurality of element wires 13 that are located close to the bottom portion 23a. Accordingly, the element wires 13 are less likely to be displaced between the core wire 12 and the bottom portion 23a. That is, while ultrasonic vibrations are being applied, the core wire 12 and the bottom portion 23a are less likely to be displaced relative to each other, so that it is possible to easily widen the contact area in which they are brought into proximity to each other to such a degree that their metal atoms can be bonded together, thus making it possible to obtain a good ultrasonically joined region over a wide range. Furthermore, the contact area between the core wire 12 and the electric wire connection portion 22 can be increased as much as possible. Accordingly, the end portion of the core wire 12 and the bottom portion 23a can be joined with as high a joining strength as possible.

In particular, according to the present embodiment, the bottom portion 23a is supported by the placement portion in an orientation in which the bottom portion 23a gradually recedes from the pressing portion 35 toward the distal end side of the core wire 12. Accordingly, the force directed to the distal end side can be easily exerted on the element wires 13 of the core wire 12.

In particular, with the ultrasonic joining device 30, it is difficult to change the sonotrode 34 that transmits ultrasonic vibrations in view of the impact on the vibration propagation property and the like, whereas it is relatively easy to change the shape and the like of the anvil 32. This also provides an advantage that it is relatively easy to change the design and the like such that the anvil 32 supports the bottom portion 23a in an inclined orientation.

Moreover, a part of the placement portion 33 of the anvil 32 that is located on the distal end side of the core wire 12 is formed in a simple shape that is recessed via the step portion 33S, thus allowing the shape to be easily formed compared with the case where the entire placement portion 33 is formed as an inclined surface.

### Modifications

Based on the above-described embodiment, various modifications will be described.

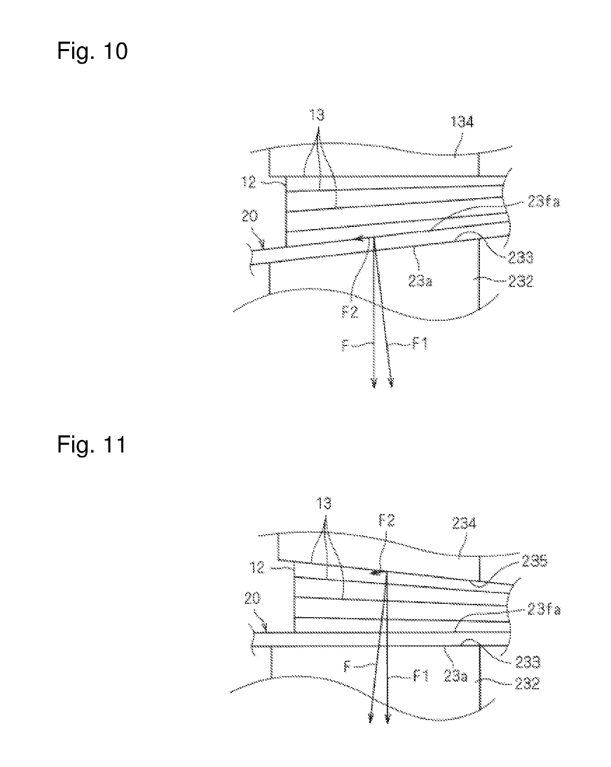

FIG. 10 is a schematic diagram showing an anvil 132 according to a first modification. In the first modification, an upward placement portion 133 of the anvil 132 corresponding to the anvil 32 is formed in an inclined shape that gradually lowers toward the distal end side of the core wire 12. Accordingly, as in the above-described embodiment, it is possible to perform ultrasonic joining while exerting a force F that presses the sonotrode 34 downward as a force. F1 that perpendicularly presses the plurality of element wires 13 (including those located close to the bottom portion 23a) included in the core wire 12 against the surface to be joined 23fa of the bottom portion 23a, and a force F2 that pushes the plurality of element wires 13 toward the distal end side of the core wire 12. Accordingly, it is possible to achieve the same effects as those achieved by the above-described embodiment except for the effect provided by forming the step portion 33S.

FIG. 11 is a schematic diagram showing an anvil 232 and a sonotrode 234 according to a second modification. In this modification, an upward placement portion 233 of the anvil 232 corresponding to the anvil 32 is in a horizontal orientation. Instead, a downward pressing portion 235 of the sonotrode 234 corresponding to the sonotrode 34 is inclined gradually upwardly (in a direction away from the placement portion 233) toward the distal end side of the core wire 12. Accordingly, it is possible to perform ultrasonic joining while exerting a force F with which the pressing portion 235 of the sonotrode 234 pushes the core wire 12 as a force F1 that perpendicularly presses a plurality of element wires 13 (including those located close to the bottom portion 23a) included in the core wire 12 against the surface to be joined 23fa of the bottom portion 23a, and a force F2 that pushes the plurality of element wires 13 toward the distal end side of the core wire 12. Accordingly, it is possible to achieve the same effects as those achieved by the above-described embodiment except for the effect provided by forming the shape that supports the bottom portion 23a in an inclined orientation on the anvil 32 side.

The first modification and the second modification described above are examples of the method and the device for performing ultrasonic joining in a state in which the interval between the positions at which the anvil 132, 232 and the sonotrodes 134, 234 respectively pressurize the stack of the end portion of the core wire 12 and the bottom portion 23a gradually increases toward the distal end side of the core wire 12, at least partly in the direction in which the core wire 12 extends.

Note that it is also possible to adopt a configuration in which both the placement portion and the pressing portion are inclined. Alternatively, either one of the placement portion and the pressing portion may be partly inclined along the direction in which the core wire 12 extends, and the remaining part may be inclined in the horizontal direction or the opposite direction.

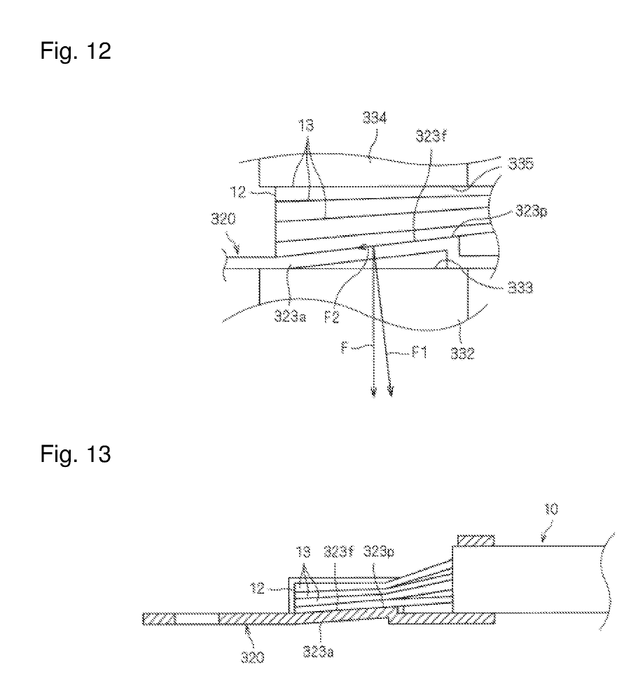

FIGS. 12 and 13 are schematic diagrams showing a terminal 320 according to a third modification. In this modification, an upward placement portion 333 of the anvil 332 corresponding to the anvil 32 is in a horizontal orientation. In addition, a downward pressing portion 335 of the sonotrode 334 corresponding to the sonotrode 34 is also in a horizontal orientation. That is, the ultrasonic joining device itself has the same configuration as that of a commonly used ultrasonic joining device.

Instead, a bottom portion 323a of the terminal 320 corresponding to the terminal 20 is formed in a shape having an inclined surface 323f whose height distance gradually decreases toward the counterpart connection portion 21. Here, the central part of the bottom portion 323a in the width direction is formed so as to partly protrude toward a first principal surface side (side where the core wire 12 is to be joined), thus forming a projection 323p. The projection 323p looks like a recess when the bottom portion 323a is viewed from the opposite side. Then, a surface of the projection 323p that is located on the side where the side wall portion 23b is to be formed is formed as an inclined surface 323f whose height distance gradually decreases toward the counterpart connection portion 21.

According to this modification, by supporting the bottom portion 323a so as to be placed on the placement portion 233 in a horizontal orientation, disposing the core wire 12 thereon, and pressing the core wire 12 thereagainst by the pressing portion 35, the interval between the inclined surface 323f and the pressing portion 35 gradually decreases toward the distal end side of the core wire 12. Accordingly, the force F with which the sonotrode 334 is directed downward acts as a force F1 that perpendicularly presses the plurality of element wires 13 (including those located close to the inclined surface 3230 included in the core wire 12 against the inclined surface 323f, and a force F2 that pushes the plurality of element wires 13 to the distal end side of the core wire 12, thus allowing the end portion of the core wire 12 and the bottom portion 323a to be joined with as high a joining strength as possible, as in the above-described embodiment.

Although the embodiment and the modifications have been described, taking an example in which the core wire 12 and the terminal 20 as an object to be joined are joined, the object to be joined may also be another metal object such as a core wire 512.

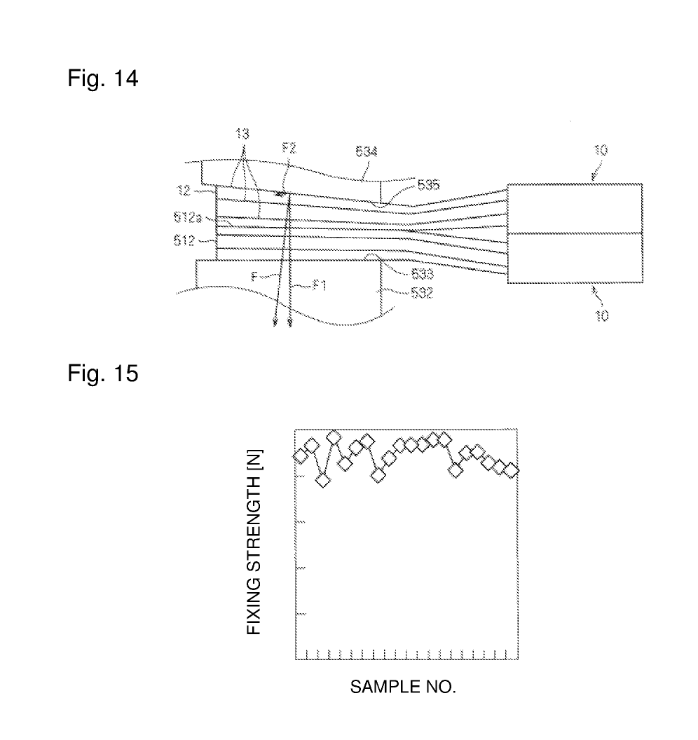

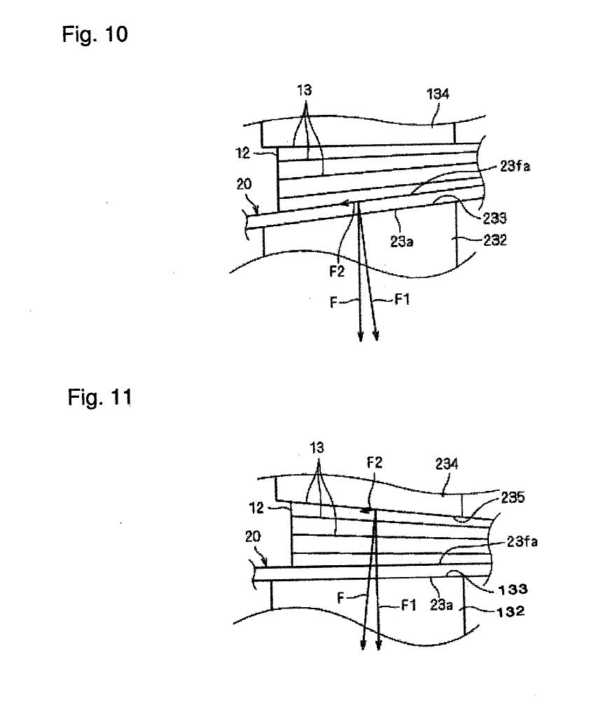

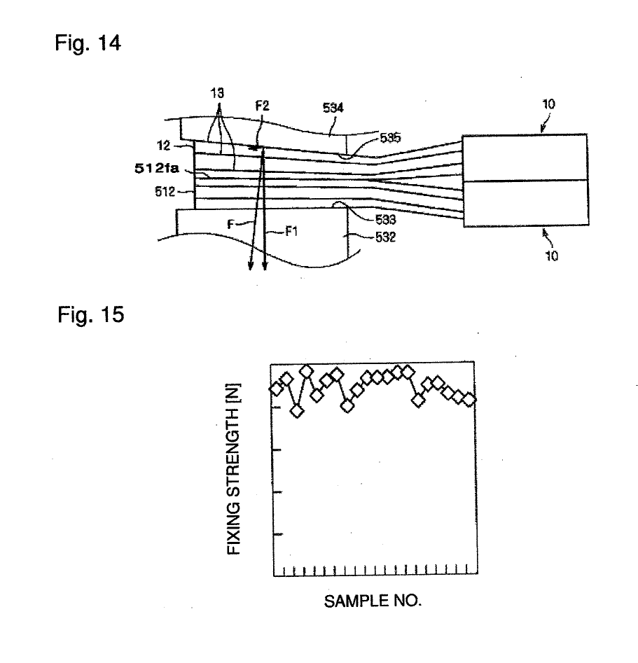

In a fourth modification shown in FIG. 14, the core wire 12 and another core wire 512 are pressurized between an anvil 532 and a sonotrode 534 while being stacked on each other, and the core wire 12 and the other core wire 512 are ultrasonically joined in this state.

Here, an upward placement portion 533 of the anvil 532 corresponding to the anvil 32 is in a horizontal orientation, and a downward pressing portion 535 of the sonotrode 534 corresponding to the sonotrode 34 is gradually inclined upwardly (in a direction away from the placement portion 233) toward the distal end side of the core wire 12. Accordingly, it is possible to perform ultrasonic joining while exerting a force F with which the pressing portion 535 of the sonotrode 534 pushes the core wire 12 as a force F1 that perpendicularly presses a plurality of element wires 13 (including those located close to the core wire 512) included in the core wire 12 against a surface to be joined 512fa of the core wire 512, and a force F2 that pushes the plurality of element wires 13 to the distal end side of the core wire 12. This allows the core wires 12, 512 to be joined with as high a joining strength as possible.

Note that the configurations described in the embodiments and the modifications may be combined as appropriate as long as there are no contradictions. For example, it is possible to support the terminal in an obliquely inclined orientation by the anvil 32, while pressing the core wire 12 by the pressing portion in an obliquely inclined orientation.

Although the present invention has been described above in detail, the foregoing description is in all aspects illustrative and the invention is not limited thereto. It will be appreciated that numerous modifications not illustrated herein can be made without departing from the scope of the present invention.

Note that FIG. 15 is a graph showing the relationship between Sample No. and the fixing strength when the core wire 12 and the terminal 20 were actually ultrasonically joined by a method according to the above-described embodiment. As shown in FIG. 15, it was found that a stable fixing strength was obtained for many samples.

### LIST OF REFERENCE NUMERALS

10 Electric wire
12 Core wire
13 Element wire
20, 320 Terminal
21 Counterpart connection portion
22 Electric wire connection portion
23 Core wire connection portion
23a, 323a Bottom portion
23fa Surface to be joined
30 Ultrasonic joining device
32, 132, 232, 332, 532 Anvil
33, 133, 233, 333, 533 Placement portion
33S Step portion
34, 134, 234, 334, 534 Sonotrode
35, 235, 335, 535 Pressing portion
40 Ultrasonic vibration source
323f Inclined surface
323p Projection
512 Core wire
512fa Surface to be joined

1. A joined product of a core wire and an object to be joined, comprising:
a core wire including a plurality of element wires; and
an object to be joined that has been ultrasonically joined to the core wire while being stacked on the core wire, wherein
a distance between a part of the core wire that has been joined to the object to be joined and a part of the core wire that is located opposite thereto gradually increases toward a distal end side of the core wire, at least partly in a direction in which the core wire extends.

2. The joined product of a core wire and an object to be joined according to claim 1, wherein
the object to be joined is a core wire connection portion of a terminal.

3. A terminal comprising:
a core wire connection portion including a plate-shaped part; and
a counterpart connection portion provided continuously with one end portion of the core wire connection portion, wherein
the plate-shaped part includes an inclined surface whose height gradually decreases toward the counterpart connection portion.

4. An ultrasonic joining device for ultrasonically joining a core wire including a plurality of element wires and an object to be joined, comprising:
a pair of pressurization members that sandwich therebetween a stack of an end portion of the core wire and an object to be joined; and
an ultrasonic vibration source that applies ultrasonic vibrations to one of the pair of pressurization members, wherein
an interval between a surface to be joined of the object to be joined that is supported by one of the pair of pressurization members and a part of the other of the pair of pressurization members that presses the end portion of the core wire is set to gradually increase toward a distal end side of the core wire, at least partly in a direction in which the core wire extends.

5. The ultrasonic joining device according to claim 4, wherein
one of the pair of pressurization members includes a placement portion that supports the object to be joined, with the object to be joined placed thereon,
the other of the pair of pressurization members includes a pressing portion that presses an end portion of the core wire that is stacked on the object to be joined, and
the placement portion is shaped so as to support the object to be joined in an orientation in which the object to be joined gradually recedes from the pressing portion toward the distal end side of the core wire.

6. The ultrasonic joining device according to claim 5, wherein
the placement portion is shaped so as be recessed on the distal end side of the core wire, and to support the object to be joined such that the object to be joined is inclined downward at the distal end side of the core wire.

7. A method for joining a core wire and an object to be joined for ultrasonically joining a core wire including a plurality of element wires and an object to be joined, comprising:
sandwiching a stack of an end portion of the core wire and an object to be joined between a pair of pressurization members; and
ultrasonically joining the stack of the end portion of the core wire and the object to be joined sandwiched between the pair of pressurization members in a condition in which a force directed to a distal end side of the core wire is exerted on those of the plurality of element wires that are located on a side of the object to be joined.

8. The method for joining a core wire and an object to be joined according to claim 7, wherein,
the ultrasonic joining is performed in a condition in which an interval between a surface to be joined of the object to be joined that is supported by one of the pair of pressurization members and a part with which the other of the pair of pressurization members presses the end portion of the core wire gradually increases toward a distal end side of the core wire, at least partly in a direction in which the core wire extends.

9. The method for joining a core wire and an object to be joined according to claim 7, wherein,
in the step (b), the ultrasonic joining is performed in a condition in which an interval between positions at which the pair of pressurization members respectively pressurize the stack of the end portion of the core wire and the object to be joined gradually increases toward a distal end side of the core wire, at least partly in a direction in which the core wire extends.

10. The method for joining a core wire and an object to be joined according to claim 7, wherein
the object to be joined is a core wire connection portion of a terminal.
